(19) United States
(12) Patent Application Publication
(10) Pub. No.: US 2014/0340002 A1
(43) Pub. Date: Nov. 20, 2014

(54) DRIVING CONTROL APPARATUS AND DRIVING CONTROL METHOD FOR ULTRASONIC MOTOR

(71) Applicant: CANON KABUSHIKI KAISHA, Tokyo (JP)

(72) Inventor: Yoshifumi NISHIMOTO, Machida-shi (JP)

(73) Assignee: CANON KABUSHIKI KAISHA, Tokyo (JP)

(21) Appl. No.: 14/270,537

(22) Filed: May 6, 2014

(30) Foreign Application Priority Data
May 14, 2013 (JP) 2013-102006
Apr. 30, 2014 (JP) 2014-093263

(51) Int. Cl. H02N 2/14

(52) U.S. Cl. CPC H02N 2/14
USPC 318/116

(57) ABSTRACT

To keep velocities of a plurality of ultrasonic motors equal; and to suppress the deterioration of the performance, the occurrence of noise and the decrease of the life have been unavoidable problems, a first drive signal and/or a second drive signal are values that are corrected by values obtained from characteristics of a first ultrasonic motor, which are detected by making a second ultrasonic motor generate a standing wave and making the first ultrasonic motor generate a traveling wave, and characteristics of the second ultrasonic motor, which are detected by making the first ultrasonic motor generate a standing wave and making the second ultrasonic motor generate a traveling wave.

### BACKGROUND OF THE INVENTION

1. Field of the Invention

The present invention relates to a driving control method of controlling the driving of an object member to be driven by combining driving forces transmitted from a plurality of ultrasonic motors, and a driving control apparatus thereof.

2. Description of the Related Art

Conventionally, when one rotary shaft or an object member to be driven which is connected to the rotary shaft is driven with the use of a plurality of ultrasonic motors, there has been the case where the rotating velocity exhibits individual difference according to each ultrasonic motor. Because of this, each motor cannot sufficiently show its performance, or sliding occurs in internal frictional contacts of a part or all of ultrasonic motors due to difference among the rotating velocities to induce the occurrence of noise and/or the decrease of the life (Japanese Patent Application Laid-Open No. H07-039173).

An ultrasonic motor according to the above described conventional example applies an AC voltage to a piezoelectric body which is stuck to an elastic body, makes the elastic body generate elliptical vibration, and makes a rotating body which is brought in pressing contact with the elastic body cause a rotating motion due to the frictional force which works between the rotating body and the elastic body.

Conventionally, the rotating velocities of the plurality of ultrasonic motors have been controlled so as to become equal, by using such properties that the size of a voltage value generated in the piezoelectric body along with the vibration of the elastic body correlates with the rotating velocity of the ultrasonic motor. Thereby, a certain effect has been obtained for such problems that the performance of the motor deteriorates, noise occurs and the life decreases, which originate in the above described difference among the rotating velocities.

However, in the above described conventional example, as for the velocity, a vibration voltage value generated in the piezoelectric body is used merely as a velocity value, and the velocities of the plurality of ultrasonic motors are not made equal.

For instance, dissociation would occur between the vibration voltage value which is detected from a mechanical piezoelectric body and the rotating velocity value, due to a change of a piezoelectric coefficient value of the piezoelectric body along with a change of a temperature, a change of a pressurization force along with passage of time, and the like. As a result, it becomes difficult to keep the velocities of the plurality of ultrasonic motors equal, and the above described deterioration of the performance, occurrence of noise, and decrease of the life have been unavoidable problems.

### SUMMARY OF THE INVENTION

According an aspect of the present invention, a driving control apparatus comprises: a first ultrasonic motor configured to rotate a first gearing according to a first drive signal; a second ultrasonic motor configured to rotate a second gearing according to a second drive signal; and an object member to be driven by a third gearing to be rotated by engaging the third gearing with the first and second gearings, wherein the first drive signal is corrected based on a value calculated based on a characteristics of the first ultrasonic motor detected by generating a standing wave by the second ultrasonic motor and by generating a traveling wave by the first ultrasonic motor.

According a further aspect of the present invention, a driving control method comprises: supplying a first drive signal to a first ultrasonic motor to rotate a first gearing; supplying a second drive signal to a second ultrasonic motor to rotate a second gearing; and rotating a third gearing by the first and second gearings, to drive an object member, wherein the first drive signal is corrected based on a correction value preliminary calculated, the correction value is a value calculated based on a characteristics of the first ultrasonic motor detected by generating a standing wave by the second ultrasonic motor and by generating a traveling wave by the first ultrasonic motor.

Further features of the present invention will become apparent from the following description of exemplary embodiments with reference to the attached drawings.

### BRIEF DESCRIPTION OF THE DRAWINGS

FIG. 1 is a block diagram for describing a configuration example of a driving control apparatus of an ultrasonic motor in one exemplary embodiment of the present invention.

FIG. 2A is a view illustrating a relationship between a drive frequency and a rotating velocity of a plurality of ultrasonic motors before correction processing, and a difference among the velocities of the plurality of motors, in one exemplary embodiment of the present invention.

FIG. 2B is a view illustrating a relationship between the drive frequency and the rotating velocity of the plurality of ultrasonic motors after the correction processing, in one exemplary embodiment of the present invention.

FIG. 3A is a view illustrating a relational expression between the drive frequency and the rotating velocity of the ultrasonic motors, and a correction expression for the drive frequency, according to the present invention.

FIG. 3B is a view illustrating a relational expression between the drive frequency and the rotating velocity of the ultrasonic motors, and a correction expression for the drive frequency, according to the present invention.

FIG. 4 is a view illustrating a relationship between a phase difference of a 2-phase drive voltage to be applied to the ultrasonic motor and a torque of the ultrasonic motor, according to the present invention.

FIG. 5A is a view illustrating a process flow for acquiring velocity characteristics when a motor to be detected is determined to be an ultrasonic motor 1, according to the present invention.

FIG. 5B is a view illustrating a process flow for acquiring a driving condition of an ultrasonic motor 2 other than the ultrasonic motor 1 to be detected in the process flow described in FIG. 5A, according to the present invention.

FIG. 6 is a view illustrating a process flow for correcting a drive frequency in a velocity control operation, according to the present invention.

### DESCRIPTION OF THE EMBODIMENTS

Preferred embodiments of the present invention will now be described in detail in accordance with the accompanying drawings.

An embodiment for carrying out the present invention will be described below in detail, but the present invention is not limited to such an embodiment.

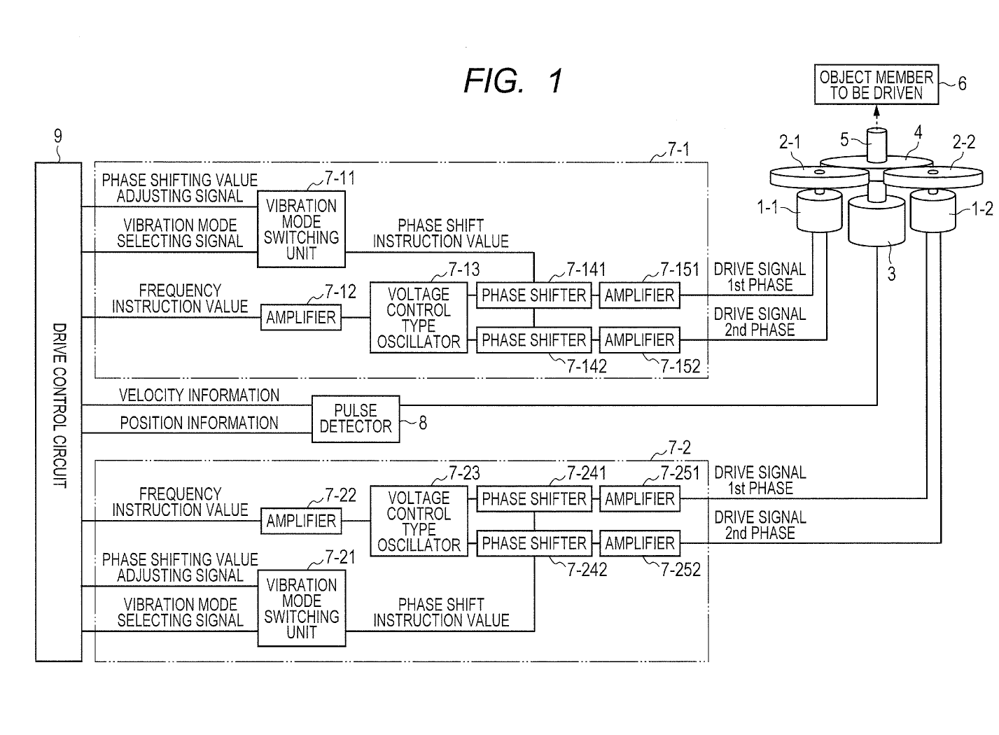

FIG. 1 is a block diagram for describing a configuration example of a driving control apparatus of an ultrasonic motor in one embodiment of the present invention.

In FIG. 1, an example is illustrated in which two ultrasonic motors (first ultrasonic motor and second ultrasonic motor) are used as a plurality of ultrasonic motors, but the ultrasonic motors do not necessarily need to be two, but three or more ultrasonic motors can be combined.

A driving apparatus for the ultrasonic motor of the present embodiment includes a vibrating body which generates vibration by a frequency signal that is applied to an electro-mechanical transducer element, and a contact body which comes in contact with the vibrating body. In addition, the driving apparatus includes a power transmission mechanism which combines driving forces transmitted from the plurality of ultrasonic motors which are configured so that this vibrating body and the contact body relatively move, and transmits the resultant driving force to the object member to be driven.

Specifically, as is illustrated in FIG. 1, a first gearing 2-1 is mounted on a rotary shaft of a first ultrasonic motor 1-1, and a second gearing 2-2 is mounted on a rotary shaft of a second ultrasonic motor 1-2.

The first ultrasonic motor 1-1 and the second ultrasonic motor 1-2 each have a vibrating body which is formed of a piezoelectric element and an elastic body, and a contact body (rotating body) which receives a pressing force from a pressing mechanism and is brought in pressure-contact with the vibrating body. Here, when frequency signals having different phases are applied to the piezoelectric elements, a progressive vibration wave is generated in each of the vibrating bodies, and each of the rotary shafts is rotated together with the contact body by a frictional force working between the vibrating body and the contact body.

Incidentally, any type of ultrasonic motor may be used such as so-called an annular type and a rod type.

The first gearing 2-1 and the second gearing 2-2 are engaged with a third gearing 4, and the third gearing 4 is provided with an output shaft 5.

The rotative forces of the ultrasonic motors are each transmitted to the third gearing 4 through the gearings mounted on the rotary shafts, respectively, and the rotative forces are combined in the third gearing 4. The resultant rotative force is output from the output shaft 5.

Here, the first ultrasonic motor 1-1 and the second ultrasonic motor 1-2 are connected to an object member 6 to be driven through the first gearing 2-1, the second gearing 2-2 and the output shaft 5. Because of this, the object member 6 to be driven is operated by receiving a combined driving force of forces transmitted from the first ultrasonic motor 1-1 and the second ultrasonic motor 1-2.

The output shaft 5 is connected to a rotation detector 3 such as a rotary encoder, and the rotation detector 3 is configured so as to send velocity information and position information to a drive control circuit 9 through a pulse detector 8.

The object member 6 to be driven of the present exemplary embodiment can be applied to an electrically moving platform apparatus which rotates a TV camera and the like mounted thereon, an electrically moving stage which is linearly operated in a semiconductor manufacturing apparatus, and the like. Then, a suitable ultrasonic actuator can be achieved by having the object member to be driven which has been applied to such an apparatus and the driving apparatus for the ultrasonic motor.

A drive control circuit 9 controls the rotating velocity of the first ultrasonic motor 1-1 through a first drive voltage generating circuit 7-1.

Similarly, the drive control circuit 9 is configured so as to control the rotating velocity of the second ultrasonic motor 1-2 through a second drive voltage generating circuit 7-2.

Next, a configuration and an operation of the drive voltage generating circuit 7-1 will be described below.

A first voltage signal sent from the drive control circuit 9 is connected to a voltage control type oscillator 7-13 through an amplifier 7-12, and a frequency signal corresponding to the size of the voltage signal is output from the voltage control type oscillator 7-13.

The frequency signal passes through phase shifters 7-141 and 7-142, and thereby is divided into two signals which have a relative phase difference of approximately 90 degrees or 0 degrees to each other. The signals are supplied as 2-phase drive voltage signals (drive signals) to the first ultrasonic motor through amplifiers 7-151 and 7-152, respectively, and the first ultrasonic motor is rotated.

In addition, the phase difference between the above described frequency signals can be selected so as to be 90 degrees or 0 degrees by a vibration mode selecting signal, and furthermore can also be adjusted to around 90 degrees or around 0 degrees by a phase shifting value adjusting signal.

As has been described above, a frequency of the frequency signal of the voltage control type oscillator 7-13 varies according to the voltage signal sent from the drive control circuit 9, and thereby the rotating velocity of the first ultrasonic motor 1-1 is controlled according to the frequency.

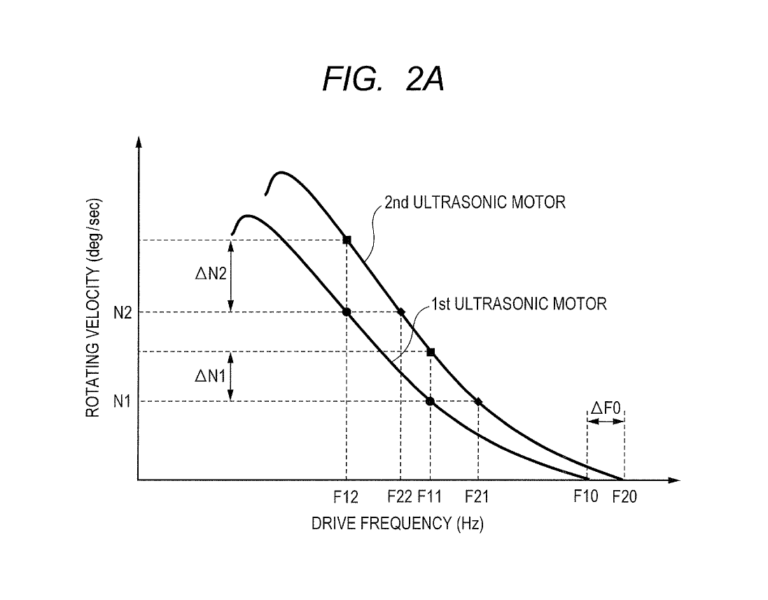

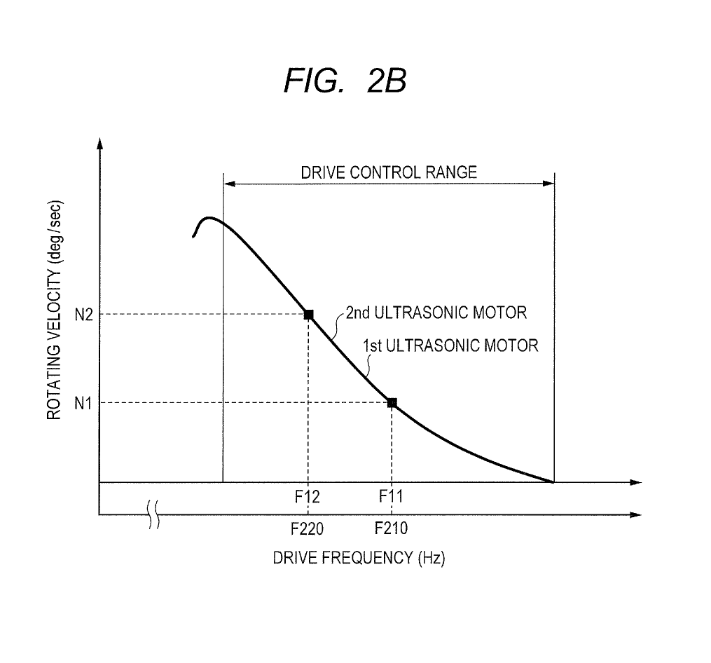

FIG. 2A illustrates a relationship between a drive voltage frequency and the rotating velocity of the ultrasonic motor.

Characteristics illustrated here are not specific characteristics to the present invention, but the ultrasonic motor of the conventional example has similar characteristics.

The following two characteristics differences concerning the drive voltage frequency occur between the first ultrasonic motor and the second ultrasonic motor.

Firstly, the difference is an offset occurring in an abscissa axis direction in the figure. As is illustrated in the figure, a frequency value at which the velocity becomes 0 exhibits a difference of ΔF0 between the first and second ultrasonic motors.

Secondarily, a difference is also observed in the amounts of the changes of the rotating velocity when the frequency has been varied, in other words, in gradients of curves of the rotating velocity with respect to the change of the frequency.

As a result, as is illustrated in the figure, when each of the ultrasonic motors is driven at the same frequency of F11, the ultrasonic motors exhibit a difference of the rotating velocity of ΔN1, and when each of the ultrasonic motors is driven at the same frequency of F12, the ultrasonic motors exhibit a difference of the rotating velocity of ΔN2.

This difference of the rotating velocity causes sliding in a shear direction on a boundary on which the rotating body comes in contact with the vibrating body in each of the ultrasonic motors, and accordingly such inconveniences would occur that the rotation performance of the ultrasonic motor deteriorates, noise occurs, and the life decreases due to the increase of the abrasion on the contact surface.

The difference of the characteristics, which exists between each of these ultrasonic motors, originates in individual difference of characteristics of drive voltage frequency among the vibrating bodies, due to a dimensional error occurring in the manufacture of the vibrating bodies, or an error of a pressing force between the vibrating body and the rotating body, which occurs when the motor is assembled.

Furthermore, these individual differences occasionally vary along with the elapsed time of driving, and accordingly even if the above described individual difference is at an acceptable level in an early period after the driving started, the individual difference could increase after a period of time has passed, and such inconveniences could occur that the above described performance deteriorates, noise occurs and the life decreases.

A method for solving the above described inconveniences will be described below with reference to the present embodiment.

FIG. 2A illustrates that a drive frequency of the first ultrasonic motor 1 which operates at a velocity N1 is F11, and on the other hand, that a drive frequency of the second ultrasonic motor 2 is F21. FIG. 2A also illustrates that the drive frequency of the first ultrasonic motor 1 which operates at a velocity N2 is F12, and on the other hand, that the drive frequency of the second ultrasonic motor 2 is F22.

This fact means that the drive frequency corresponding to an arbitrary command velocity uniquely exists for each of the ultrasonic motors.

For the case where the drive frequency corresponding to the arbitrary velocity uniquely exists as in the configuration of the present invention, a method has been devised which calculates the drive frequency value corresponding to the arbitrary command velocity based on the drive frequency value corresponding to two predetermined velocities (N1 and N2).

Properties such as the amount of the offset, the gradient and the curvature of a velocity characteristic curve of the ultrasonic motor are determined by vibration system characteristics of the ultrasonic motor, which are main factors.

The vibration amplitude which determines the rotating velocity is expressed by the following expression.

Vibration amplitude A=K/(1−ω²/p²)

ω: Vibration frequency of excitation force
p: Eigen frequency of motor vibration system
K: Proportional constant

Even though the individual difference in the above described amounts of the offset and the gradient has occurred among the motors due to a manufacture error, a basic shape of the rotating velocity characteristic curve becomes a shape which follows the above described expression of the vibration amplitude.

In other words, the above fact means that when numerical values of the combination of the rotating velocity and the drive frequency can be obtained for two points on the curve, a relationship between the rotating velocity and the drive frequency can be estimated also for other points than the two points.

In the present embodiment, a method which will be described below is carried out.

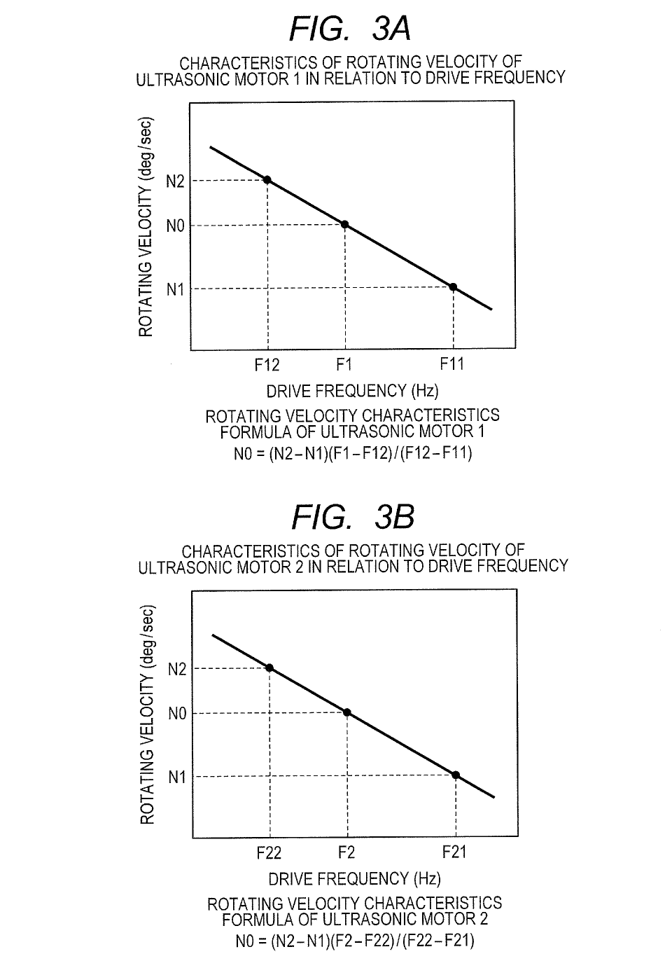

The characteristics of the drive frequency and the rotating velocity in the first ultrasonic motor 1 and the second ultrasonic motor 2 in FIG. 2A are illustrated in FIG. 3A and FIG. 3B while changing the form, for the simplicity of description.

From the figures, relational expressions between the drive frequency and the operation velocity necessary for the motors to operate at an arbitrary command velocity N0 are expressed by:

N0=(N2−N1)(F1−F12)/(F12−F11) for the first ultrasonic motor 1; and

N0=(N2−N1)(F2−F22)/(F22−F21) for the second ultrasonic motor 2.

Furthermore, from the above described two expressions, the following relational expression is obtained which shows a relationship between F1 and F2.

F2=(F22−F21)(F1−F12)/(F12−F11)+F22

The meaning of the present relational expression is to clarify combinations (F11 and F12) and (F21 and F22) of the drive frequencies which correspond to two predetermined velocities (N1 and N2) of each of the ultrasonic motors. When these combinations are found, F2 may be given to the motor 2 in order that the motor 2 is rotated at the same velocity as that of the motor 1 which is rotated at the drive frequency F1.

A correction calculation has been conducted for FIG. 2A by using this relational expression and FIG. 2B illustrates the example. In the figure, it is understood that both of the ultrasonic motors rotate at approximately same velocity in a drive region.

When the above described rotating velocity characteristics of each of the ultrasonic motors are detected, each of the ultrasonic motors in a mechanically connected state is individually accurately detected by being subjected to the following processing. The ultrasonic motor which is used in the present embodiment is configured so that 2-phase drive voltage signals (drive signals) are input into the ultrasonic motor. Usually, the ultrasonic motor is configured so that the phase difference of the 2-phase drive voltage signals (drive signals) is set at 90 degrees and thereby a traveling wave vibration which is generated in the vibrating body of the ultrasonic motor generates a rotation torque and performs axial rotation.

In the present embodiment, usually, the vibration mode switching units of 7-11 and 7-21 illustrated in FIG. 1 are set so that the phase difference becomes 90 degrees, and produce the traveling wave vibration in both of the first ultrasonic motor 1 and the second ultrasonic motor 2. However, the units are configured so that when the rotating velocity characteristics are detected, the setting for the phase difference is switched to 0 degrees only for an ultrasonic motor other than the ultrasonic motor to be detected. When the phase difference is set so as to be 0 degrees, the vibrating body of the ultrasonic motor generates the standing wave vibration, and not only the rotation torque disappears but also a frictional contact period of time greatly decreases. Thereby a frictional force in a rotating direction also decreases, and accordingly the ultrasonic motor becomes a state in which an axial torque is small (0 or close to 0) when being viewed from the motor to be detected.

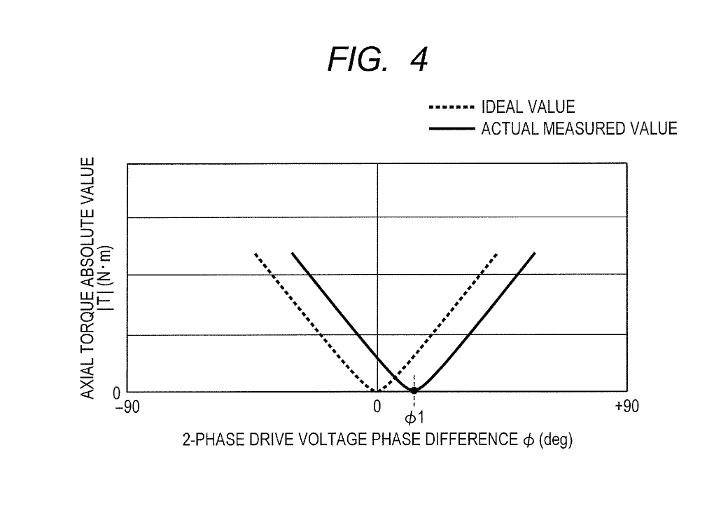

The characteristic curve of a dashed line in FIG. 4 illustrates the state in which the axial torque is zero.

Due to this effect, the rotating velocity characteristics can be accurately detected while the ultrasonic motor to be detected is not affected by the axial torque of the ultrasonic motor other than the ultrasonic motor to be detected.

However, in an actual ultrasonic motor, the phase difference at which the axial torque becomes zero is occasionally shifted slightly due to a manufacture error such as a dimension error of the piezoelectric element and/or a misalignment error. This state is a state in which the axial torque is close to zero, and is shown by a characteristic curve of a solid line in FIG. 4.

In the present embodiment, as is illustrated in “process flow for acquiring velocity characteristics” which will be described later, the optimal standing wave driving condition is acquired according to processing illustrated in “flow for acquiring standing wave driving condition”, in advance of detecting the velocity characteristics. Then, the velocity characteristics of the ultrasonic motor to be detected shall be acquired in a state in which the motor other than the motor to be detected is driven based on the obtained conditions.

Next, a series of operations for a driving control apparatus according to a driving control method of the present invention will be described below.

(1) Turn power source of driving apparatus on.

<Processing Steps (2) to (5) for Acquiring Velocity Characteristics of First Ultrasonic Motor 1>

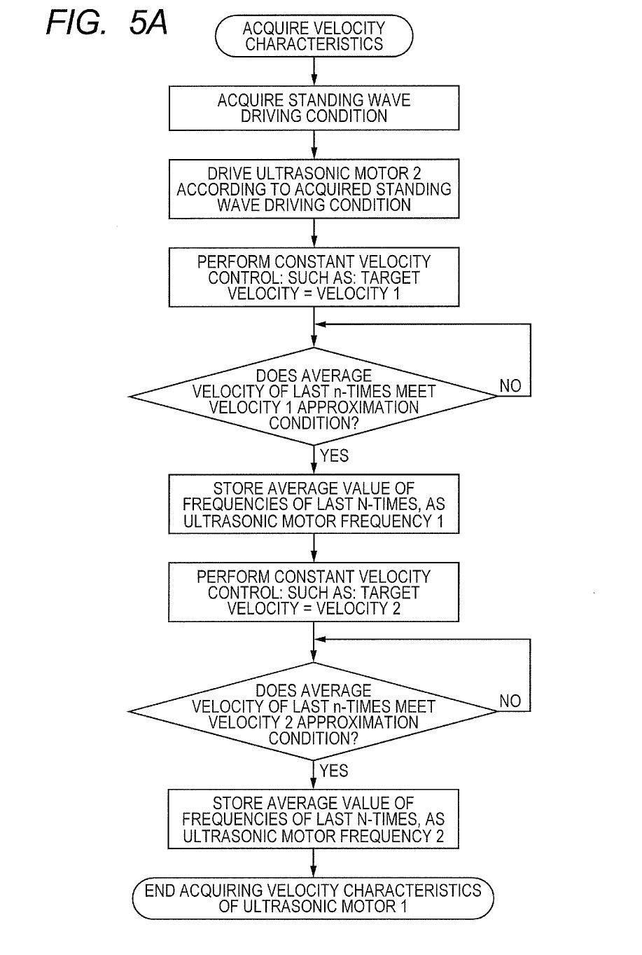

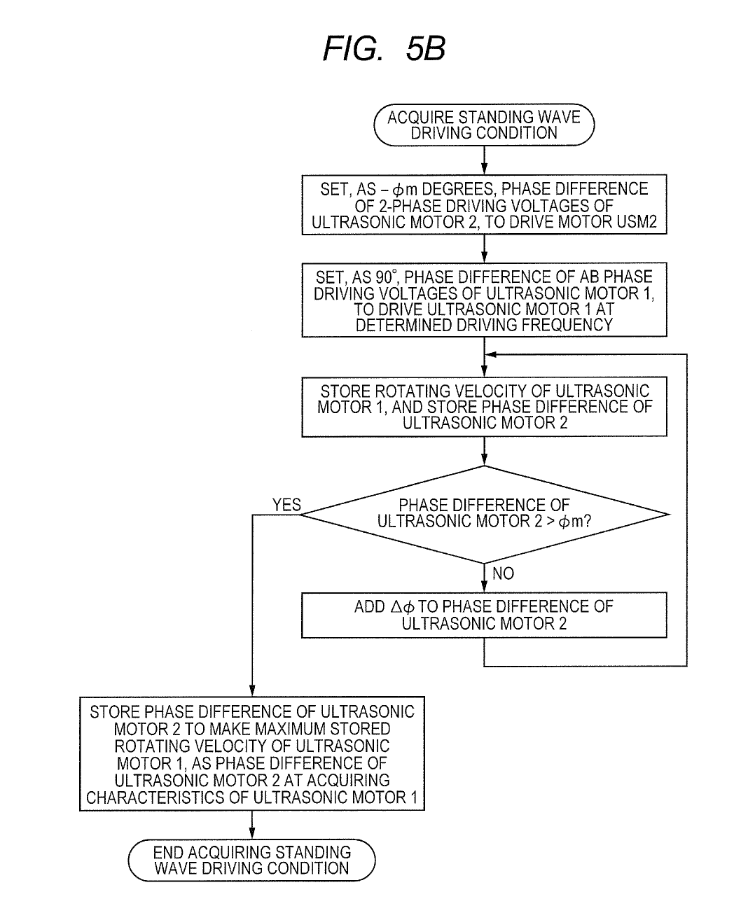

(2) Start operation for acquiring velocity characteristics of first ultrasonic motor 1 according to “process flow for acquiring velocity characteristics” described in FIG. 5A.

(3) Perform operation for acquiring standing wave driving condition of second ultrasonic motor 2, according to “flow for acquiring standing wave driving condition” described in FIG. 5B.

Scan phase difference between 2-phase drive voltages finely around 0 degrees, and store phase difference at which rotating velocity of first ultrasonic motor 1 becomes largest (phase difference at which axial torque of standing wave driving motor is small (phase difference that is close to 0 or more preferably is 0)), as standing wave driving condition of ultrasonic motor 2.

(4) Drive second ultrasonic motor 2 with standing wave on the standing wave driving condition which has been stored in the above described processing step (3), and perform acquisition of velocity characteristics of first ultrasonic motor 1.

In the present embodiment, averaging processing and the like illustrated in FIG. 5A are performed so as to minimize a detection error due to external disturbance and the like, but these are not indispensable.

(5) Complete operation of acquiring velocity characteristics, and store data obtained in processing steps (3) and (4), as velocity characteristic values of first ultrasonic motor 1.

The stored values of first ultrasonic motor 1 are as follows:

drive frequency value F11 corresponding to rotating velocity N1; and
drive frequency value F12 corresponding to rotating velocity N2.

<Processing Steps (6) to (9) for Acquiring Velocity Characteristics of Second Ultrasonic Motor 2>

(6) Start operation for acquiring velocity characteristics of second ultrasonic motor 2 according to “process flow for acquiring velocity characteristics” described in FIG. 5A.

(7) Perform operation for acquiring standing wave driving condition of first ultrasonic motor 1, according to “flow for acquiring standing wave driving condition” described in FIG. 5B.

Scan phase difference between 2-phase drive voltages finely around 0 degrees, and store phase difference at which rotating velocity of first ultrasonic motor 1 becomes largest (phase difference at which axial torque of standing wave driving motor is small (phase difference that is close to 0 or more preferably is 0)), as standing wave driving condition of first ultrasonic motor 1.

(8) Drive first ultrasonic motor 1 with standing wave on the standing wave driving condition which has been stored in the above described processing step (3), and perform acquisition of velocity characteristics of second ultrasonic motor 2.

In the present exemplary embodiment, averaging processing and the like illustrated in FIG. 5A are performed so as to minimize the detection error due to external disturbance and the like, but these are not indispensable.

(9) Complete operation of acquiring velocity characteristics, and store data obtained in processing steps (7) and (8), as velocity characteristic values of second ultrasonic motor 2.

The stored values of second ultrasonic motor 2 are as follows:

drive frequency value F21 corresponding to rotating velocity N1; and
drive frequency value F22 corresponding to rotating velocity N2.

<Operations (10) to (13) for Controlling First Ultrasonic Motor 1 and Second Ultrasonic Motor 2>

(10) Set both first ultrasonic motor 1 and second ultrasonic motor 2 to traveling wave vibration mode with vibration mode switching unit, if there is external command or operation start condition is satisfied, and start velocity control.

(11) Start detection of velocity detecting signal (velocity signal).

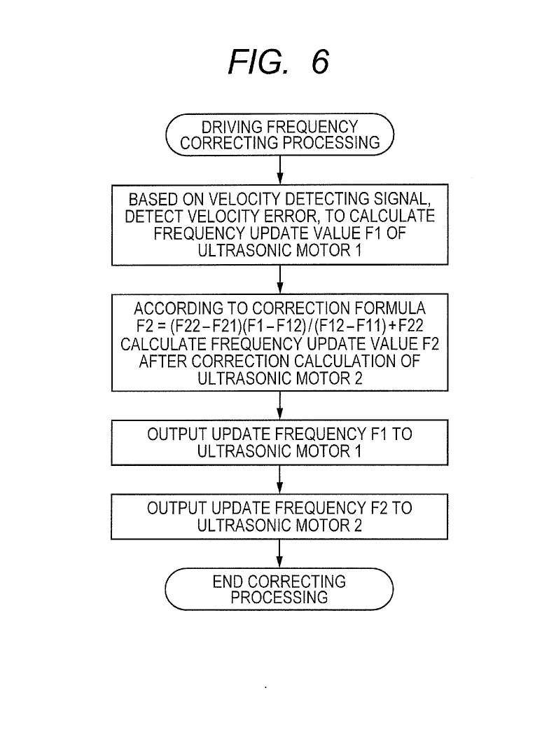

(12) Perform operation for controlling first ultrasonic motor 1 and second ultrasonic motor 2, according to “process flow for correcting drive frequency” described in FIG. 6.

Specifically, the velocity of the first ultrasonic motor 1 is detected by the velocity detecting signal (velocity signal), and a frequency updated value (correction value) F1 is calculated so as to attain a target velocity.

Then, a frequency updated value (correction value) F2 after the correction calculation of the second ultrasonic motor 2 is calculated according to the following correction formula.

F2=(F22−F21)(F1−F12)/(F12−F11)+F22

Then, the frequency updated value (correction value) F1 is output to the first ultrasonic motor 1, and the frequency updated value (correction value) F2 is output to the second ultrasonic motor 2.

Here, the example has been described in which the correction value F1 is output to the first ultrasonic motor 1 and the correction value F2 is output to the second ultrasonic motor 2, but the effect of the present invention 1 can be obtained also by rotating the first ultrasonic motor and the second ultrasonic motor 2 only so that the velocities of the first ultrasonic motor 1 and the second ultrasonic motor 2 become equal. In this case, F1 is set at the detected velocity (velocity signal) of the first ultrasonic motor 1, and only the frequency updated value F2 which has been calculated according to the correction formula may be output to the second ultrasonic motor 2.

(13) End control operation when there is stop command from outside or stop condition is satisfied, and stop operation.

The above processing steps are flow of a series of operation, but the operations in the processing steps (2) to (9) for acquiring the velocity characteristics do not need to be performed every time.

The processing steps are performed only after a fixed period of time has passed or after a fixed number of times of operations have been performed so as to update the velocity characteristic value, and thereby even when the velocity characteristics of the ultrasonic motors have been changed, inconveniences such as the deterioration of the characteristics, the occurrence of abnormal noise and the decrease of the life can be avoided.

The present invention relates to a driving control method for an ultrasonic motor, which controls the driving of a plurality of ultrasonic motors, and a driving control apparatus for the ultrasonic motor.

According to the present invention, when an object member to be driven is driven by a resultant force of driving forces transmitted from a plurality of ultrasonic motors, it is possible to reduce the deterioration of the performance of the motor, the occurrence of noise and the decrease of the life, without causing the complication of the structure, the increases of the outer dimension and the weight of the apparatus, and an increase of the cost. In addition, even when dissociation has occurred between the vibration detection value and the rotating velocity due to a change of a temperature, the passage of a driving period of time and the like, it is possible to reduce the deterioration of the performance of the motor, the occurrence of noise and the decrease of the life.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-102006, filed May 14, 2013, and Japanese Patent Application No. 2014-093263, filed Apr. 30, 2014, which are hereby incorporated by reference herein in their entirety.

What is claimed is:

1. A driving control apparatus comprising:
a first ultrasonic motor configured to rotate a first gearing according to a first drive signal;
a second ultrasonic motor configured to rotate a second gearing according to a second drive signal; and
an object member to be driven by a third gearing to be rotated by engaging the third gearing with the first and second gearings, wherein
the first drive signal is corrected based on a value calculated based on a characteristics of the first ultrasonic motor detected by generating a standing wave by the second ultrasonic motor and by generating a traveling wave by the first ultrasonic motor.

2. The driving control apparatus according to claim 1, wherein
the second drive signal is corrected based on a value calculated based on a characteristics of the second ultrasonic motor detected by generating a standing wave by the first ultrasonic motor and by generating a traveling wave by the second ultrasonic motor.

3. The driving control apparatus according to claim 1, wherein
the characteristics of the first ultrasonic motor is calculated,
under a condition of generating the standing wave by the second ultrasonic motor,
based on a relation between a velocity signal of the first ultrasonic motor and a third drive signal at a time of generating the traveling wave by the first ultrasonic motor according to the third drive signal, and
based on a relation between the velocity signal of the first ultrasonic motor and a fourth drive signal at a time of generating the traveling wave by the first ultrasonic motor according to the fourth drive signal.

4. The driving control apparatus according to claim 2, wherein
the characteristics of the second ultrasonic motor is calculated,
under a condition of generating the standing wave by the first ultrasonic motor,
based on a relation between a velocity signal of the second ultrasonic motor and a fifth drive signal at a time of generating the traveling wave by the second ultrasonic motor according to the fifth drive signal, and
based on a relation between the velocity signal of the second ultrasonic motor and a sixth drive signal at a time of generating the traveling wave by the second ultrasonic motor according to the sixth drive signal.

5. The driving control apparatus according to claim 3, wherein
the standing wave generated by the second ultrasonic motor is generated according to the seventh drive signals having a phase difference set to reduce an axial torque of the second gearing.

6. The driving control apparatus according to claim 4, wherein
the standing wave generated by the first ultrasonic motor is generated according to the eighth drive signals having a phase difference set to reduce an axial torque of the first gearing.

7. A driving control method comprising:
supplying a first drive signal to a first ultrasonic motor to rotate a first gearing;
supplying a second drive signal to a second ultrasonic motor to rotate a second gearing; and
rotating a third gearing by the first and second gearings, to drive an object member, wherein
the first drive signal is corrected based on a correction value preliminary calculated,
the correction value is
a value calculated based on a characteristics of the first ultrasonic motor detected by generating a standing wave by the second ultrasonic motor and by generating a traveling wave by the first ultrasonic motor.

8. The driving control method according to claim 7, wherein
the second drive signal is corrected based on a correction value preliminary calculated,
the correction value is
a value calculated based on a characteristics of the second ultrasonic motor detected by generating a standing wave by the first ultrasonic motor and by generating a traveling wave by the second ultrasonic motor.

9. The driving control method according to claim 7, wherein
the characteristics of the first ultrasonic motor is calculated,
under a condition of generating the standing wave by the second ultrasonic motor,
based on a relation between a velocity signal of the first ultrasonic motor and a third drive signal at a time of generating the traveling wave by the first ultrasonic motor according to the third drive signal, and
based on a relation between the velocity signal of the first ultrasonic motor and a fourth drive signal at a time of generating the traveling wave by the first ultrasonic motor according to the fourth drive signal.

10. The driving control method according to claim 8, wherein
the characteristics of the second ultrasonic motor is calculated,
under a condition of generating the standing wave by the first ultrasonic motor,
based on a relation between a velocity signal of the second ultrasonic motor and a fifth drive signal at a time of generating the traveling wave by the second ultrasonic motor according to the fifth drive signal, and
based on a relation between the velocity signal of the second ultrasonic motor and a sixth drive signal at a time of generating the traveling wave by the second ultrasonic motor according to the sixth drive signal.

11. The driving control method according to claim 9, wherein
the standing wave generated by the second ultrasonic motor is generated according to the seventh drive signals having a phase difference set to reduce an axial torque of the second gearing.

12. The driving control method according to claim 10, wherein
the standing wave generated by the first ultrasonic motor is generated according to the eighth drive signals having a phase difference set to reduce an axial torque of the first gearing.
